(19) United States
(12) Patent Application Publication
(10) Pub. No.: US 2026/0012787 A1
(43) Pub. Date: Jan. 8, 2026

(54) ENABLING HOME-NETWORK-TRIGGERED PRIMARY AUTHENTICATION IN MULTI-REGISTRATION SCENARIO

(71) Applicant: ZTE Corporation, Shenzhen (CN)

(72) Inventors: Peilin LIU, Shenzhen (CN); Shilin YOU, Shenzhen (CN); Yuze LIU, Shenzhen (CN); Wei MA, Shenzhen (CN)

(21) Appl. No.: 19/323,789

(22) Filed: Sep. 9, 2025

Related U.S. Application Data
(63) Continuation of application No. PCT/CN2023/087116, filed on Apr. 7, 2023.

(51) Int. Cl. H04W 12/06

(52) U.S. Cl. CPC H04W 12/06

(57) ABSTRACT

Systems, methods, and apparatus for wireless communication are described. A wireless communication method includes receiving, by a network node, multiple mobile network registrations. The method further includes determining, by the network node and based on the multiple mobile network registrations, an access and mobility management function (AMF) or a security anchor function (SEAF). The method further includes transmitting, by the network node, an authentication message to the AMF or the SEAF. The described techniques may be adopted by a network device or by a wireless device.

### CROSS-REFERENCE TO RELATED APPLICATIONS

This application is a continuation of International Patent Application No. PCT/CN2023/087116, filed on Apr. 7, 2023, the contents of which are incorporated herein by reference in their entirety.

### TECHNICAL FIELD

This patent document is directed generally to wireless communications.

### BACKGROUND

Mobile telecommunication technologies are moving the world toward an increasingly connected and networked society. In comparison with the existing wireless networks, next-generation systems and wireless communication techniques will need to support a much wider range of use-case characteristics and provide a more complex and sophisticated range of access requirements and flexibilities.

Long-Term Evolution (LTE) is a standard for wireless communication for mobile devices and data terminals developed by 3rd Generation Partnership Project (3GPP). LTE Advanced (LTE-A) is a wireless communication standard that enhances the LTE standard. The 5th generation of wireless system, known as 5G, advances the LTE and LTE-A wireless standards and is committed to supporting higher data rates, large number of connections, ultra-low latency, high reliability, and other emerging business needs.

### SUMMARY

Techniques are disclosed for triggering primary authentication procedures from the unified data management (UDM) node. The UDM node determines which access and mobility management function (AMF) or security anchor function (SEAF) runs the primary authentication procedures based on the mobile network registrations corresponding to the AMF/SEAF. The AMF/SEAF then initiates the primary authentication procedures according to mobility management states of user equipments (UEs) or authentication policies.

A first example wireless communication method includes receiving, by a network node, multiple mobile network registrations. The method further includes determining, by the network node and based on the multiple mobile network registrations, an access and mobility management function (AMF) or a security anchor function (SEAF). The method further includes transmitting, by the network node, an authentication message to the AMF or the SEAF.

A second example wireless communication method includes receiving, by an access and mobility management function (AMF) or a security anchor function (SEAF), an authentication message. The method further includes determining, by the AMF or the SEAF and in response to the authentication message, a mobility management state of a user equipment (UE) or an authentication policy local to the AMF or the SEAF. The method further includes determining, by the AMF or the SEAF and based on the mobility management state of the UE or the authentication policy, whether to run a primary authentication procedure.

In yet another exemplary embodiment, a device that is configured or operable to perform the above-described methods is disclosed. The device may include a processor configured to implement the above-described methods.

In yet another exemplary embodiment, the above-described methods are embodied in the form of processor-executable code and stored in a non-transitory computer-readable storage medium. The code included in the computer readable storage medium when executed by a processor, causes the processor to implement the methods described in this patent document.

The above and other aspects and their implementations are described in greater detail in the drawings, the descriptions, and the claims.

### BRIEF DESCRIPTION OF THE DRAWINGS

FIG. 1 illustrates an exemplary authentication procedure.

FIG. 2 illustrates another exemplary authentication procedure.

FIG. 3 illustrates yet another exemplary authentication procedure.

FIG. 4 illustrates an exemplary home-network-triggered authentication procedure.

FIG. 5 is an exemplary flowchart for transmitting an authentication message.

FIG. 6 is an exemplary flowchart for determining whether to run a primary authentication procedure.

FIG. 7 illustrates an exemplary block diagram of a hardware platform that may be a part of a network device or a communication device.

FIG. 8 illustrates exemplary wireless communication including a Base Station (BS) and User Equipment (UE) based on some implementations of the disclosed technology.

### DETAILED DESCRIPTION

The example headings for the various sections below are used to facilitate the understanding of the disclosed subject matter and do not limit the scope of the claimed subject matter in any way. Accordingly, one or more features of one example section can be combined with one or more features of another example section. Furthermore, 5G terminology is used for the sake of clarity of explanation, but the techniques disclosed in the present document are not limited to 5G technology only and may be used in wireless systems that implemented other protocols.

### I. Introduction

In the fifth generation (5G) system, the home network control over the security of the user equipment (UE) has been strengthened compared to previous generations by many new mechanisms such as Subscription Permanent Identifier (SUPI) privacy, termination of the authentication procedure in the home network, and the provisions for increased home network control and linkage to subsequent procedures. However, when it comes to triggering the authentication, this is still under the control of the serving network.

The home network uses Authentication Server Function (AUSF) key (K_{AUSF}) or keys derived from KAUSF to provide protection for various services, e.g., interworking from long term evolution (LTE) to 5G, Steering of Roaming (SoR)/UE parameter update (UPU) and Authentication and Key Management for Application (AKMA) services, and hence the home network would benefit from having the ability to be able to ensure a fresh KAUSF is available by triggering an authentication, in particular to prevent counter wrap in SoR/UPU or after interworking from LTE when there might be no KAUSF available.

The above describes the home-network-triggered primary authentication requirement in 3GPP TR 33.741.

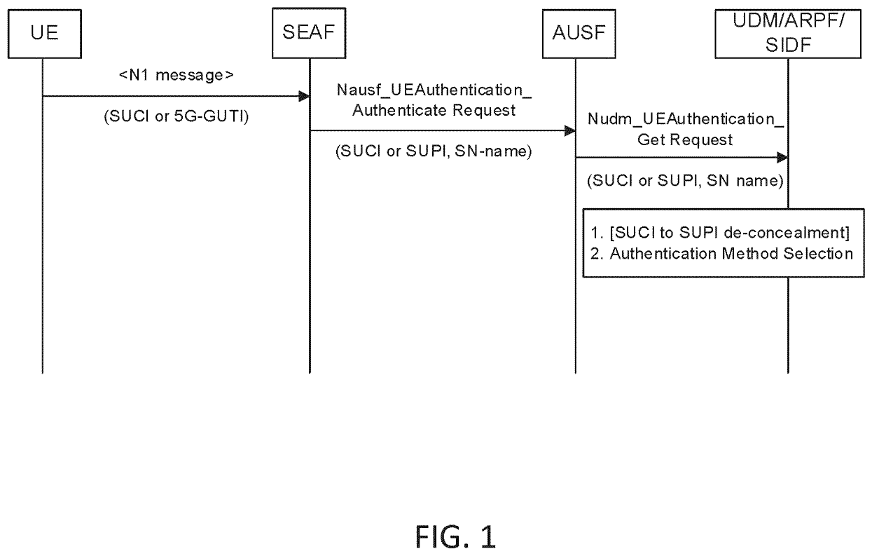

FIG. 1 shows the initiation of a primary authentication triggered by UE as described in 3GPP TS 33.501. The initiation of the primary authentication is triggered by the UE and the serving network. The UDM in the home network then selects the authentication method from Extensible Authentication Protocol (EAP) Authentication and Key Agreement (EAP-AKA′) and 5G AKA.

After the initiation of authentication triggered by the UE, UDM starts EAP-AKA′ or 5G AKA authentication procedure according to the result of authentication method selection.

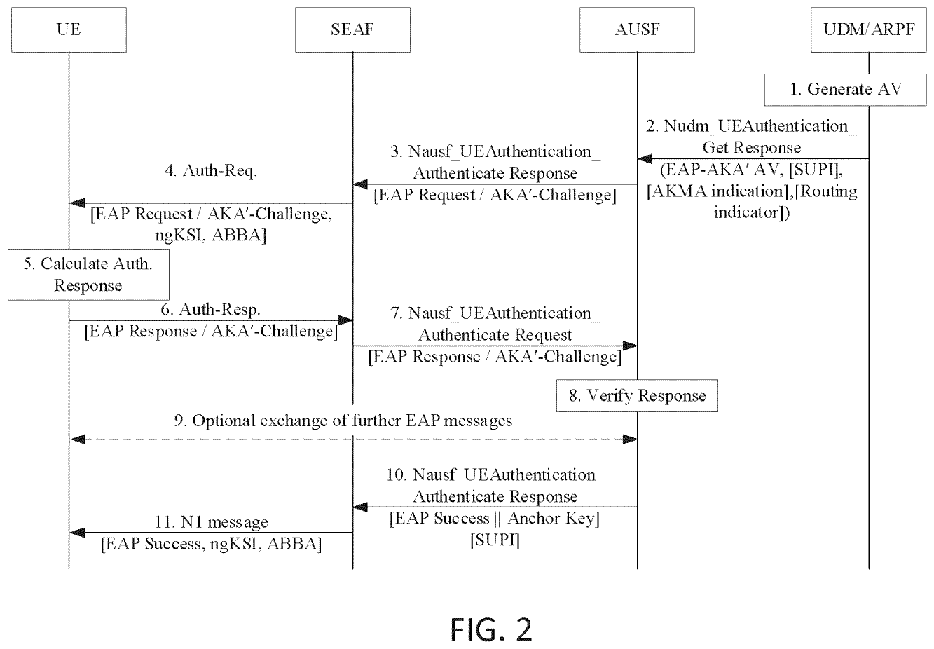

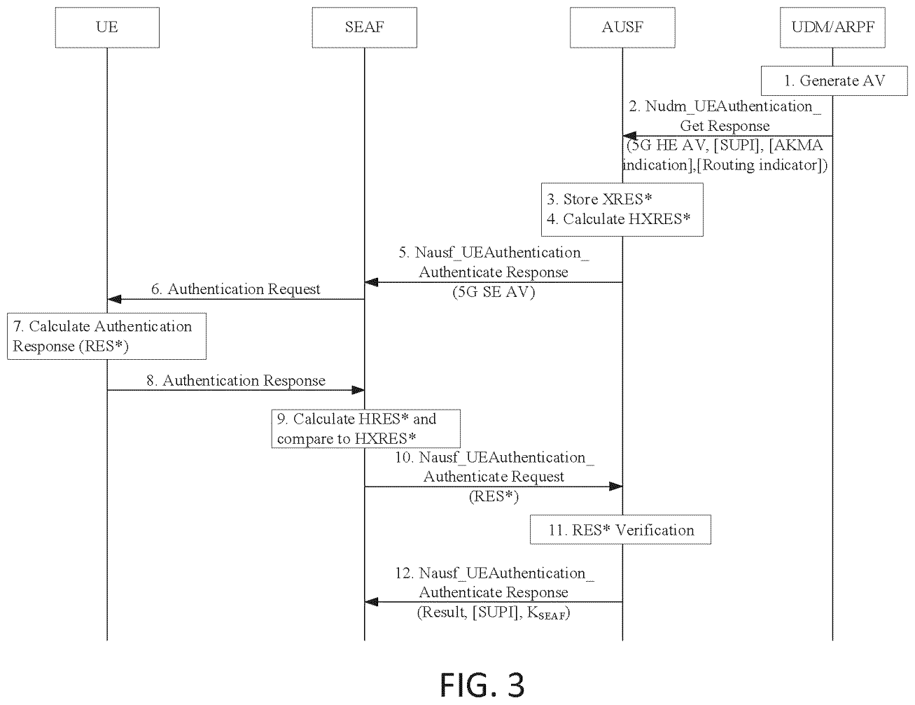

FIG. 2 and FIG. 3 show the EAP-AKA′ and 5G AKA authentication procedures as described in 3GPP TS 33.501, respectively. The EAP-AKA′ and the 5G AKA authentication procedures enable the mutual authentication between the UE and the network and provide keying material that can be used between the UE and the serving network in subsequent security procedures. The keying material generated by the primary authentication and key agreement procedure results in an anchor key called the KSEAF provided by the AUSF of the home network to the SEAF of the serving network.

The authentication procedures as shown in FIGS. 1-3 are not described in detail in this patent document. However, some basic terms that appeared in FIGS. 1-3 are given as follows to facilitate understanding of these three authentication procedures.
UE: User Equipment
AMF: Access and Mobility Management Function
SEAF: Security Anchor Function
AUSF: Authentication Server Function
UDM: Unified Data Management
AKMA: Authentication and Key Management for Applications
SoR: Steering of Roaming
UPU: UE Parameter Update
SUPI: Subscription Permanent Identifier
K_{AUSF}: Authentication Intermediate Key
K_{SEAF}: Security Anchor Key
K_{AKMA}: AKMA Anchor Key

In FIGS. 1-3, the triggering of primary authentication is still under the control of the serving network. However, if the re-authentication is triggered immediately after the authentication request from Unified Data Management (UDM), the ongoing services of the UE may get interrupted.

This patent document proposes a mechanism enabling home-network-triggered primary authentication for UEs of different connection management modes in multi-registration cases. The proposed procedure is described in Embodiment 1.

### II. Embodiment 1: Multi-Registration Scenarios

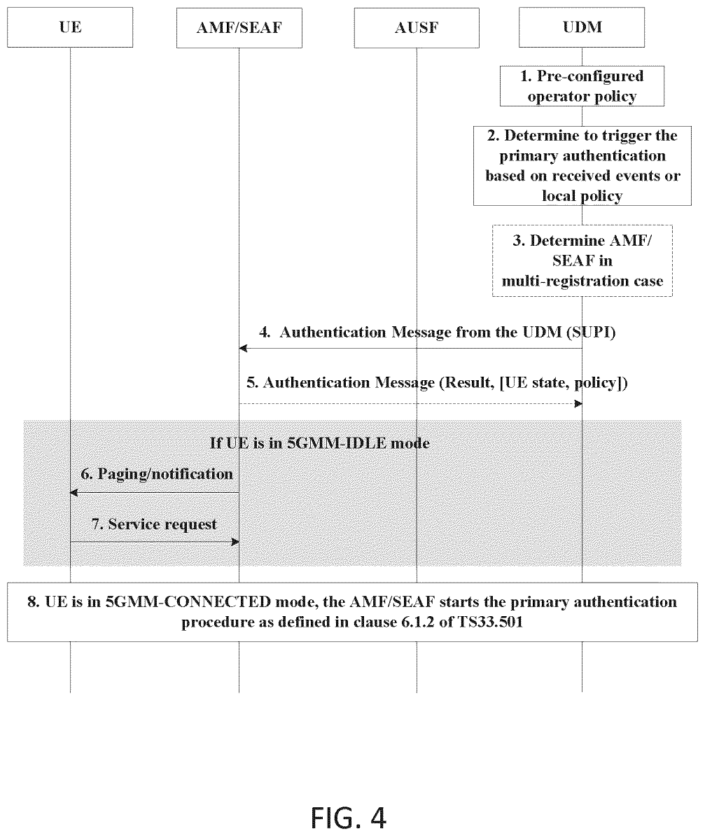

FIG. 4 shows a proposed mechanism for enabling home-network-triggered primary authentication for UEs of different connection management modes in multi-registration cases. The proposed procedure may include 8 steps.

1. The UDM may be pre-configured with an operator policy in order to determine when to trigger a primary authentication procedure. The pre-configured operator policy may include the following conditions:
a. UDM determines that the previous primary authentication of the UE is not secure anymore;
b. UDM finds that a UE supporting AKMA services does not have an AKMA Indicator;
c. UDM finds that a UE supporting SoR/UPU services does not have a corresponding K_{AUSF};
d. When it is the first time for the UE to move from Evolved Packet System (EPS) to 5G System (5GS), there is no available K_{AUSF} maintained in AUSF, and UDM could not find the AUSF identification (ID)/address;
e. A network function (NF) or a third-party Application Function (AF) sends a re-authentication request to UDM, such as in AKMA services, K_{AKMA} or KAF needs to be refreshed.

2. According to the received event or the local operator policy, if there is no ongoing primary authentication for the UE, the UDM determines to trigger the primary authentication.

3. If the target UE is multi-registered with different Public Land Mobile Network (PLMNs), the UDM determines the serving Access and Mobility Management Function (AMF)/Security Anchor Function (SEAF) as following:
a. UDM firstly selects the AMF/SEAF corresponding to the 3rd Generation Partnership Project (3GPP) registration. If the re-authentication fails as indicated by Step 5, the UDM then selects the AMF/SEAF corresponding to the non-3GPP registration; or
b. UDM firstly selects the AMF/SEAF corresponding to the latest registration (3GPP/non-3GPP). If the re-authentication fails as indicated by Step 5, the UDM then selects the AMF/SEAF corresponding to the other registration (non-3GPP/3GPP).

4. The UDM sends an authentication message to the AMF/SEAF with the UE's SUPI.

5. After receiving the authentication message from the UDM, the AMF/SEAF shall decide whether to run the primary authentication procedure based on its own local authentication policy and UE mobility management (MM) state.

If the UE cannot be reached and the AMF/SEAF cannot run a primary authentication, the AMF/SEAF sends the authentication response message to the UDM with a result indicating failure cause. The policy in the response message can be a timer after which the authentication will be executed. If the UE accesses the network before the timer goes to zero, the AMF/SEAF will stop the timer and trigger the primary authentication immediately.

If the UE is in 5G MM-CONNECTED mode and there is no ongoing service running on the UE, Steps 6-7 will be skipped and the AMF/SEAF triggers the authentication procedure as described in Step 8 without sending the authentication response message to the UDM.

If the UE is in 5G MM-CONNECTED mode and there are ongoing services running on the UE, the AMF/SEAF sends an authentication response message back to the UDM. The response message includes UE mobility management mode and the policy used to trigger the authentication. The policy can be a timer after which the authentication will be executed or just indicates the authentication will be triggered after waiting. The result in the message shall indicate that primary authentication will be triggered after the ongoing services are finished. Then, Steps 6-7 will be skipped and the AMF/SEAF triggers the authentication procedure as described in Step 8 after the waiting time.

If there is ongoing primary authentication triggered by the UE, the AMF/SEAF sends an authentication response message back to the UDM. The result in the response message shall indicate that there is ongoing primary authentication triggered by the UE.

If the UE is in 5G MM-IDLE mode, the AMF/SEAF triggers the paging/notification and primary authentication as described in Steps 6-8, and sends an authentication response message back to the UDM. The response message includes UE mobility management mode and the policy used to trigger the authentication. The policy in the response message can be a timer after which the authentication will be executed or just indicates the authentication will be triggered after waiting. The result in the message shall indicate that primary authentication will be triggered after the UE is connected.

6. If the UE is in 5G MM-IDLE mode, the AMF/SEAF sends a paging message in 3GPP registration case or a notification message in non-3GPP registration case to the UE.

7. After receiving the paging or notification message, the 5G MM-IDLE mode UE sends a service request to the AMF/SEAF to establish a service connection.

8. When the UE is in 5G MM-CONNECTED mode, the AMF/SEAF starts the primary authentication procedure as described in clause 6.1.2 of TS 33.501.

This patent document proposes a mechanism enabling home-network-triggered primary authentication for UEs of different connection management modes in multi-registration cases, specifically:

Provides AMF/SEAF selection methods in UE multi-registration scenarios;

AMF/SEAF indicating the result, UE mobility management modes, and policy to the UDM for different UE conditions, avoiding interrupting the ongoing services of the UE.

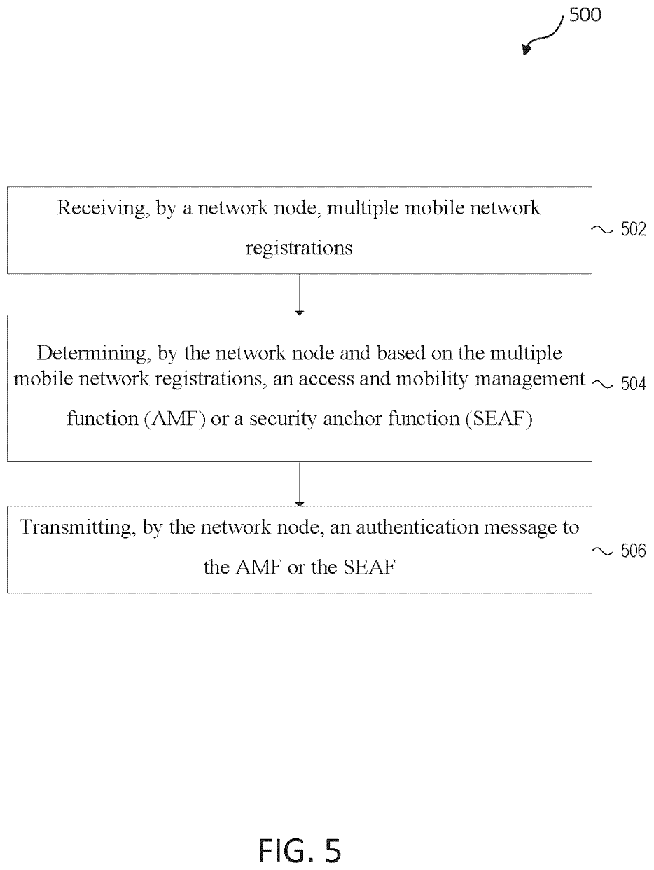

FIG. 5 is an exemplary flowchart for transmitting an authentication message. Operation 502 includes receiving, by a network node, multiple mobile network registrations. Operation 504 includes determining, by the network node and based on the multiple mobile network registrations, an access and mobility management function (AMF) or a security anchor function (SEAF). Operation 506 includes transmitting, by the network node, an authentication message to the AMF or the SEAF. In some embodiments, the method can be implemented according to Embodiment 1. In some embodiments, performing further steps of the method can be based on a better system performance than a legacy protocol.

In some embodiments, the network node includes a unified data management (UDM) node, and the multiple mobile network registrations include multiple public land mobile network (PLMN) registrations associated with a target user equipment (UE). In some embodiments, determining the AMF or the SEAF includes selecting an AMF or a SEAF corresponding to a 3rd Generation Partnership Project (3GPP) registration of the multiple mobile network registrations. In some embodiments, the method further includes receiving, by the network node, an authentication failure message, where determining the AMF or the SEAF further includes selecting an AMF or a SEAF corresponding to a non-3GPP registration of the multiple mobile network registrations.

In some embodiments, determining the AMF or the SEAF includes selecting an AMF or a SEAF corresponding to a latest registration of the multiple mobile network registrations, where the latest registration is a 3rd Generation Partnership Project (3GPP) registration or a non-3GPP registration. In some embodiments, the method further includes receiving, by the network node, an authentication failure message, where determining the AMF or the SEAF further includes selecting an AMF or a SEAF corresponding to another registration of the multiple mobile network registrations, and where the other registration is different from the latest registration.

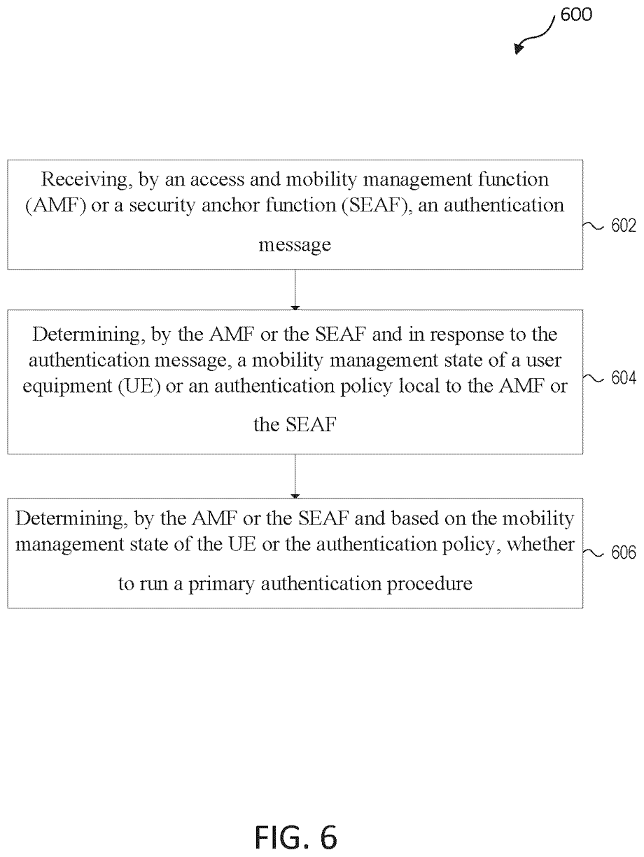

FIG. 6 is an exemplary flowchart for determining whether to run a primary authentication procedure. Operation 602 includes receiving, by an access and mobility management function (AMF) or a security anchor function (SEAF), an authentication message. Operation 604 includes determining, by the AMF or the SEAF and in response to the authentication message, a mobility management state of a user equipment (UE) or an authentication policy local to the AMF or the SEAF. Operation 606 includes determining, by the AMF or the SEAF and based on the mobility management state of the UE or the authentication policy, whether to run a primary authentication procedure. In some embodiments, the method can be implemented according to Embodiment 1. In some embodiments, performing further steps of the method can be based on a better system performance than a legacy protocol.

In some embodiments, if the UE cannot be reached and the AMF or the SEAF cannot run the primary authentication procedure, the method further includes sending, by the AMF or the SEAF, an authentication response message, where the authentication response message includes not being able to reach the UE as a cause of failure to run the primary authentication procedure. In some embodiments, the authentication response message further includes a timer, where the AMF or the SEAF initiates the primary authentication procedure after the timer expires or immediately if the UE is reached before the timer expires.

In some embodiments, the AMF or the SEAF runs the primary authentication procedure if the UE is in a connected mode and there is no ongoing service running on the UE.

In some embodiments, if the UE is in a connected mode and there is an ongoing service running on the UE, the method further includes sending, by the AMF or the SEAF, an authentication response message, where the authentication response message includes the mobility management state of the UE. In some embodiments, the authentication response message further includes a timer, where the AMF or the SEAF initiates the primary authentication procedure after the timer expires. In some embodiments, the authentication response message further includes an indication that the AMF or the SEAF initiates the primary authentication procedure after the ongoing service is finished.

In some embodiments, if there is an ongoing primary authentication procedure triggered by the UE, the method further includes sending, by the AMF or the SEAF, an authentication response message, where the authentication response message includes an indication of the ongoing primary authentication procedure triggered by the UE.

In some embodiments, if the UE is in an idle mode, the method further includes initiating, by the AMF or the SEAF, a paging or notification procedure and sending, by the AMF or the SEAF, an authentication response message, where the authentication response message includes the mobility management state of the UE. In some embodiments, the authentication response message further includes a timer, where the AMF or the SEAF initiates the primary authentication procedure after the timer expires. In some embodiments, the authentication response message further includes an indication that the AMF or the SEAF initiates the primary authentication procedure after the UE is connected.

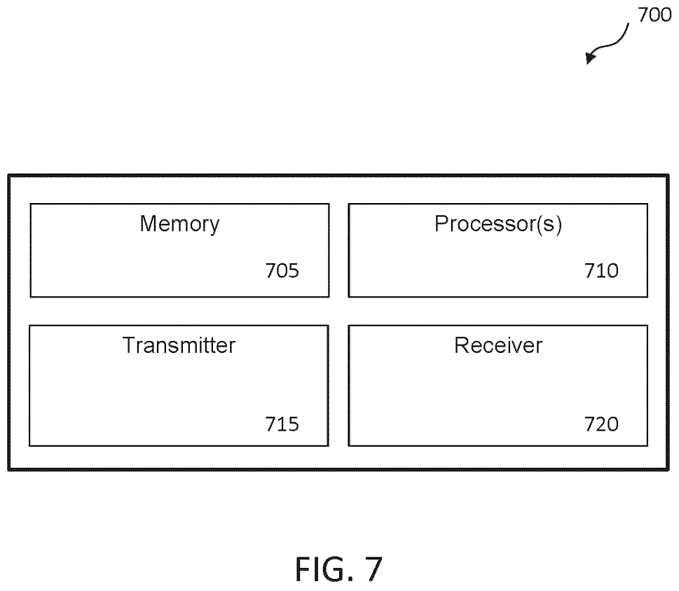

FIG. 7 shows an exemplary block diagram of a hardware platform 700 that may be a part of a network device (e.g., base station, UDM, AMF, or SEAF) or a communication device (e.g., a user equipment (UE)). The hardware platform 700 includes at least one processor 710 and a memory 705 having instructions stored thereupon. The instructions upon execution by the processor 710 configure the hardware platform 700 to perform the operations described in FIGS. 1 to 6 and in the various embodiments described in this patent document. The transmitter 715 transmits or sends information or data to another device. For example, a network device transmitter can send a message to a user equipment. The receiver 720 receives information or data transmitted or sent by another device. For example, a user equipment can receive a message from a network device. For example, a UE or a network device, as described in the present document, may be implemented using the hardware platform 700.

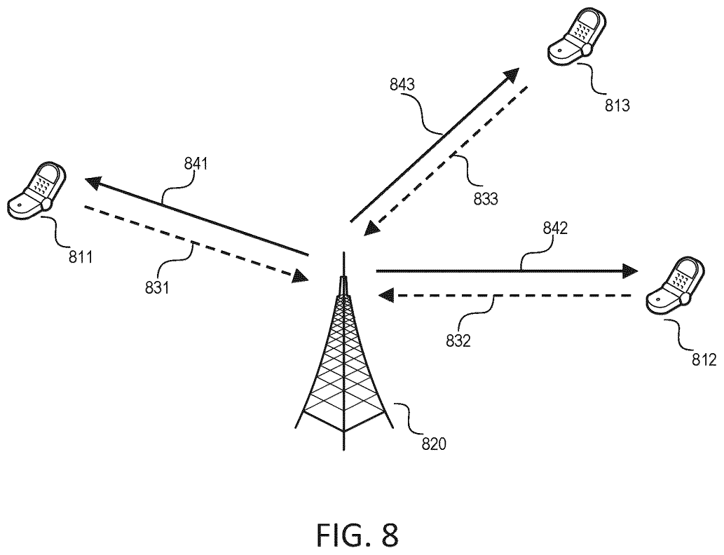

The implementations as discussed above will apply to a wireless communication. FIG. 8 shows an example of a wireless communication system (e.g., a 5G or NR cellular network) that includes a base station 820 and one or more user equipment (UE) 811, 812 and 813. In some embodiments, the UEs access the BS (e.g., the network) using a communication link to the network (sometimes called uplink direction, as depicted by dashed arrows 831, 832, 833), which then enables subsequent communication (e.g., shown in the direction from the network to the UEs, sometimes called downlink direction, shown by arrows 841, 842, 843) from the BS to the UEs. In some embodiments, the BS send information to the UEs (sometimes called downlink direction, as depicted by arrows 841, 842, 843), which then enables subsequent communication (e.g., shown in the direction from the UEs to the BS, sometimes called uplink direction, shown by dashed arrows 831, 832, 833) from the UEs to the BS. The UE may be, for example, a smartphone, a tablet, a mobile computer, a machine to machine (M2M) device, an Internet of Things (IoT) device, and so on. The UEs described in the present document may be communicatively coupled to the base station 820 depicted in FIG. 8. The UEs can also communicate with BS for CSI communications.

In some embodiments, the authentication message can be transmitted from the UDM to the AMF/SEAF. In some embodiments, the authentication message can be transmitted from the UDM to the AUSF. In some embodiments, the authentication message can be transmitted from the UDM to the UE. In some embodiments, the authentication message can be transmitted from the AUSF to the AMF/SEAF. In some embodiments, the authentication message can be transmitted from the AUSF to the UE. In some embodiments, the authentication message can be transmitted from the AMF/SEAF to the UE.

In some embodiments, the authentication response message can be transmitted from the AMF/SEAF to the UDM. In some embodiments, the authentication response message can be transmitted from the AMF/SEAF to the AUSF. In some embodiments, the authentication response message can be transmitted from the AUSF to the UDM. In some embodiments, the authentication response message can be transmitted from the UE to the UDM. In some embodiments, the authentication response message can be transmitted from the UE to the AMF/SEAF. In some embodiments, the authentication response message can be transmitted from the UE to the AUSF.

It will be appreciated by one of skill in the art that the present document discloses methods to initiate primary authentication procedures from home network nodes such as the unified data management (UDM) node. The UDM node determines which access and mobility management function (AMF) or security anchor function (SEAF) runs the primary authentication procedures based on the mobile network registrations corresponding to the AMF/SEAF. The AMF/SEAF then initiates the primary authentication procedures according to mobility management states of user equipments (UEs) or authentication policies.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

What is claimed is:

1. A method of wireless communication, comprising:
receiving, by a first network node, an authentication message;
determining, by the first network node and in response to the authentication message, a mobility management state of a user equipment (UE); and
determining, by the first network node and based on the mobility management state of the UE and an authentication policy local to the first network node, whether to run a primary authentication procedure,
wherein when the UE is in a connected mode and there is an ongoing service running on the UE, the method further comprising:
sending, by the first network node, an authentication response message, wherein the authentication response message comprises the mobility management state of the UE.

2. The method of claim 1, wherein the UE cannot be reached and the first network node cannot run the primary authentication procedure, further comprising sending, by the first network node, an authentication response message, wherein the authentication response message comprises not being able to reach the UE as a cause of failure to run the primary authentication procedure.

3. The method of claim 1, wherein when the UE is in the connected mode and there is no ongoing service running on the UE, the first network node runs the primary authentication procedure.

4. The method of claim 1, wherein the authentication response message further comprises an indication that the first network node initiates the primary authentication procedure after the ongoing service is finished.

5. The method of claim 1, wherein there is an ongoing primary authentication procedure triggered by the UE, further comprising sending, by the first network node, an authentication response message, wherein the authentication response message comprises an indication of the ongoing primary authentication procedure triggered by the UE.

6. The method of claim 1, wherein the UE is in an idle mode, further comprising:
sending, by the first network node, an authentication response message, wherein the authentication response message comprises the mobility management state of the UE.

7. The method of claim 6, wherein the authentication response message further comprises an indication that the first network node initiates the primary authentication procedure after the UE is connected.

8. The method of claim 1, wherein the first network node comprises an access and mobility management function (AMF) or a security anchor function (SEAF).

9. A method of wireless communication, comprising:
sending, to a first network node by a second network node, an authentication message,
wherein a mobility management state of a user equipment (UE) is determined in response to the authentication message,
wherein whether to run a primary authentication procedure is determined based on the mobility management state of the UE and an authentication policy local to the first network node,
wherein when the UE is in a connected mode and there is an ongoing service running on the UE, the method further comprising:
receiving, from the first network node by the second network node, an authentication response message, wherein the authentication response message comprises the mobility management state of the UE.

10. The method of claim 9, wherein the UE cannot be reached and the first network node cannot run the primary authentication procedure, further comprising receiving, from the first network node, an authentication response message, wherein the authentication response message comprises not being able to reach the UE as a cause of failure to run the primary authentication procedure.

11. The method of claim 9, wherein when the UE is in the connected mode and there is no ongoing service running on the UE, the first network node runs the primary authentication procedure.

12. The method of claim 9, wherein the first network node comprises an access and mobility management function (AMF) or a security anchor function (SEAF), and wherein the second network node comprises a unified data management (UDM) node.

13. An apparatus for wireless communication comprising at least one processor and a memory storing instructions, execution of which by the at least one processor causes the apparatus to perform operations comprising:
receiving an authentication message;
determining, in response to the authentication message, a mobility management state of a user equipment (UE); and
determining, based on the mobility management state of the UE and an authentication policy local to the apparatus, whether to run a primary authentication procedure,
wherein when the UE is in a connected mode and there is an ongoing service running on the UE, the operations further comprising:
sending an authentication response message, wherein the authentication response message comprises the mobility management state of the UE.

14. The apparatus of claim 13, wherein the UE cannot be reached and the apparatus cannot run the primary authentication procedure, the operations further comprising sending an authentication response message, wherein the authentication response message comprises not being able to reach the UE as a cause of failure to run the primary authentication procedure.

15. The apparatus of claim 13, wherein when the UE is in the connected mode and there is no ongoing service running on the UE, the apparatus runs the primary authentication procedure.

16. The apparatus of claim 13, wherein the authentication response message further comprises an indication that the apparatus initiates the primary authentication procedure after the ongoing service is finished.

17. The apparatus of claim 13, wherein there is an ongoing primary authentication procedure triggered by the UE, the operations further comprising sending an authentication response message, wherein the authentication response message comprises an indication of the ongoing primary authentication procedure triggered by the UE.

18. The apparatus of claim 13, wherein the UE is in an idle mode, the operations further comprising:
sending an authentication response message, wherein the authentication response message comprises the mobility management state of the UE.

19. The apparatus of claim 18, wherein the authentication response message further comprises an indication that the apparatus initiates the primary authentication procedure after the UE is connected.
